(19) United States
(12) Patent Application Publication
(10) Pub. No.: US 2004/0222573 A1
(43) Pub. Date: Nov. 11, 2004

(54) Method for manufacturing ceramic pieces with perforations and the corresponding device

(76) Inventor: Pablo Peris Dominguez, Castellon De La Plana (ES)

Correspondence Address: KLAUBER & JACKSON, 411 HACKENSACK AVENUE, HACKENSACK, NJ, 07601

(21) Appl. No.: 10/793,658

(22) Filed: Mar. 4, 2004

(30) Foreign Application Priority Data
Mar. 5, 2003 (ES) P20030529

(51) Int. Cl. C04B 33/32

(52) U.S. Cl. 264/678

(57) ABSTRACT

A method for manufacturing ceramic pieces with perforations comprising pressing wet powder (4) into a mold (1) from which a ceramic covering piece will be obtained. A flat body (7) that is later dried and baked is obtained with the pressing and hence, the ceramic piece is obtained. One or several perforations (8) may be made during the pressing process so that the flat powder body (7), so that the ceramic piece resulting from baking the flat powder body includes the perforation or perforations (8) that can be used for inserting or passing the elements for fastening the ceramic piece to a face. The perforations (8) are made with perforating punches (6) embedded in the pressing tamper (3) of the mold (1) and partially emerging in order to be inserted during pressing in the powder mass (4′), producing the corresponding perforations (8). The powder (4″) of each perforation is contained unpressed in the perforating punch (6) and is emptied once the pressing operation has finished. A device for making the ceramic pieces is also disclosed.

### OBJECT OF THE INVENTION

As expressed in the title of this specification, the present invention refers to a method for manufacturing ceramic pieces, based on pressing that is carried out on an amount of wet powder, wherein the particularity of the process consists of the fact that the making of the perforations or holes is done during the pressing step of the wet powder, in other words, prior to the process of drying and baking the piece.

The invention also refers to the device for carrying out the process, based on a mold wherein the pressing of the wet powder is carried out, by means of a tamper that has the particularity of having one or more perforating elements or punches comprised of respective hollow cylindrical bodies. There are as many of these elements as the number of holes or perforations to be made and they make the perforations of the powder mass in the pressing step. The powder that encompasses each punch is contained inside the punch and is emptied at the end of the operation.

### BACKGROUND OF THE INVENTION

As everyone knows, a very important part of ceramic pieces used in construction, is obtained from wet powder of appropriate material or materials, obtained by different systems. The pieces are given a shape, dimensions, front surface, back surface and side surfaces, by means of the pressing operation.

Pressing permits obtainment of a product with a certain resistance, low wetness and great similarity to the final product to be obtained, after drying and baking the same, guaranteeing dimensional stability.

Normally, the products or ceramic pieces obtained in the described manner, are to be used as covering and/or paving pieces, fastened by special mortars.

Obviously, use thereof for covering facades is dangerous due to the possibility that the pieces can come off and the risk of causing accidents to people or objects. Therefore, when these pieces are to be used on facades, complex elements that permit and ensure effective fastening of the ceramic pieces to the wall are needed and in short, this is very expensive, laborious and not easy to do.

Besides, in the event of using simple fastening elements such as screws or the like, the first thing that should be taken into account is that these fastening elements should be anticorrosive. It is always necessary to make holes in the ceramic pieces so that these fastening pieces pass through the pieces. This involves the risk that the piece itself breaks and therefore, the loss of time in making the holes and the need to use special devices or tools.

Therefore in the cited cases and in many others, such as, for example, on those occasions when it is desired to obtain heat-absorbing and sound-absorbing partitions, which are at the same time fire-resistant, it would be interesting to have perforated ceramic pieces in order to facilitate fastening thereof on any type of wall in the first case, and in order to achieve multilaminar assemblies with the presence of ceramic plates next to the plate of insulating material, in the second case, then they could be attached by mortar bands applied to the perforations or holes of the ceramic pieces.

### DESCRIPTION OF THE INVENTION

By means of the process of the invention, it is possible to achieve ceramic pieces with perforations, making these perforations during the step itself when the wet powder is pressed, in such a way that once the perforation or perforations has (have) been made in the product or piece, the piece would then be subjected to the corresponding drying and baking thereof in order to obtain the final ceramic piece with the perforation or perforations that has (have) been previously considered, depending on the final use. The piece will not need to be perforated as traditionally done, with the risk of the same breaking and all the above-cited inherent problems, all as a result that the ceramic piece obtained at the end of the process already has the perforations that may be used for passing the fastening elements and/or fastening the ceramic piece itself on any type of wall.

The process is based on perforating the wet powder mass from which the ceramic piece in question is going to be obtained, during the pressing step of said material, in such a way that the powder corresponding to the perforation or perforations to be made, is retained in the corresponding perforating element or elements.

As to the device for carrying out the process, it is based on a conventional mold with the shape of the piece to be obtained, whose base upon which the wet powder to be pressed is deposited includes a specific rubber sheet upon which the wet powder is precisely placed, while the corresponding pressing tamper will have, on its operative surface, as many punches or perforating elements as perforations are to be made in the ceramic piece to be obtained. The perforating element or elements, comprised of cylindrical bodies, are hollow and embedded in the body of the tamper, emerging partially from the operative surface of the tamper, whose emerging part will have the same thickness or will be thicker than the wet powder mass after being pressed, in order to be able to carry out the total perforation.

When the powder is pressed, the part that delimits the cylindrical body or punch as a perforating element will contain the volume of powder corresponding to the perforation that is made, being emptied into the resulting hollow when the pressing operation has ended.

The product thus obtained, by pressing the wet powder, with the perforation or perforations made, is subsequently subjected to the conventional steps of drying and baking in order to obtain the final ceramic piece.

The rubber sheet provided in the bottom of the base of the mold on which the wet powder is placed and pressed, will have in the area opposite the perforating punch or punches a sufficient thickness so that it yields and prevents the destruction of said perforating punches in the pressing.

### BRIEF DESCRIPTION OF THE DRAWINGS

In order to complete the description that is going to be made hereinafter and in order to provide a better understanding of the characteristics of the invention, the present specification is accompanied by a set of drawings on the basis of which the innovations and advantages of the process and device object of the invention will be more easily understood.

FIG. 1 is a schematic section view of the device in an inoperative position in order to make the perforations in a wet powder mass contained in the mold, and which will constitute a ceramic piece.

FIG. 2 is a schematic view like the one of the preceding figure after the pressing step of the wet powder.

FIG. 3 is a plan view of the pressed product obtained, with the shape of the ceramic piece that is sought, and with the perforation made in the process shown in the preceding figures, said perforation being filled with the powder that has been removed by the perforating element or punch.

FIG. 4 shows the product represented in the preceding figure with the perforation without any powder, which may correspond to the final ceramic piece in the event that same has been subjected to the drying and baking processes.

### DESCRIPTION OF THE PREFERRED EMBODIMENT

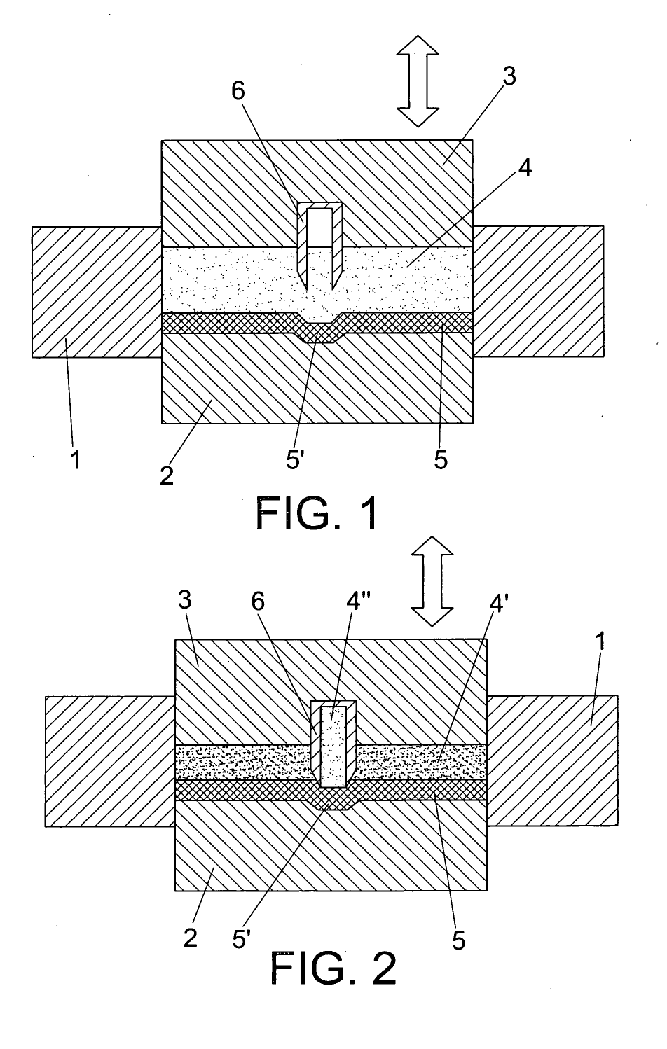

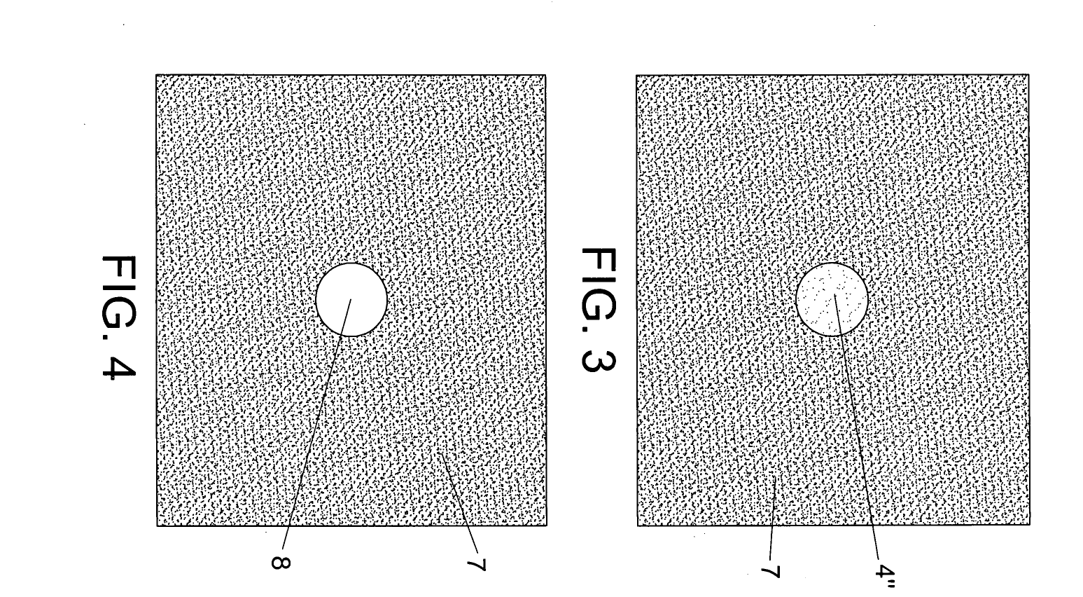

In view of the commented figures, and in connection with FIGS. 1 and 2, one can see a mold (1) where the pressing process object of the invention takes place, a mold that includes a base (2) and a top tamper (3), which is the one that is going to carry out the pressing of a wet powder mass (4) contained in the mold. Said powder mass (4) is deposited on a specific rubber sheet (5) located on the top part of the base (2), as clearly shown in FIGS. 1 and 2. This rubber sheet (5) has one or more deformations (5′) that defines (define) an appropriate thickness that is opposite the corresponding perforating punches (6) that are partially embedded in the tamper (3) of the mold, all for the purpose so that in the pressing step the front edge of those perforating punches (6) do not reach the base (2), thus preventing them from breaking or becoming worn.

From the inoperative step of FIG. 1, the descent of the tamper (3) involves the pressing of the wet powder (4), obtaining a thickness (4′) of that wet powder as represented in FIG. 2, that is going to correspond to the shape that the final piece is to have as the ceramic piece once the drying and baking process thereof has been carried out.

In this pressing process the perforating punch (6), or the perforating punches in the event that the tamper has several of them, sticks (stick) in the wet powder and an amount of mass or wet powder (4″) that will correspond to that of the perforation that is made by means of the perforating element or punch (6) is located therein, and whose powder mass (4″) removed and contained in the perforating punches (6) is emptied once the operation has ended.

In this way a product or piece (7), like the one represented in FIG. 2, is obtained, with the perforation filled with powder (4″) that had been contained in the perforating element or punch (6), in such a way that once this powder mass (4″) has been emptied, the piece (7), represented in FIG. 4, with the corresponding perforation (8), once dried and baked, is going to be a ceramic piece with one or several perforations (8), depending on the ones that have been made previously in the pressing step of the wet powder, as material from which the ceramic piece in question is obtained. This piece may be used for the purposes already mentioned, and fastened to any wall by means of appropriate fastening elements that are made to pass through the perforation or perforations (8).

1. Method for manufacturing ceramic pieces with perforations, based on the pressing of wet powder in order to achieve a flat body that is subsequently subjected to a drying and baking process in order to achieve the final ceramic piece, wherein it comprises making one or several holes during the pressing step of the wet powder, defining one or several perforations passing through the flat body of the pressed powder, from which the final ceramic piece is obtained.

2. Method for manufacturing ceramic pieces with perforations, according to claim 1, wherein the wet powder mass resulting from the perforation or perforations that is (are) made is contained and remains unpressed in the corresponding perforating element or elements, being emptied once the pressing operation has ended.

3. Device for making perforations in ceramic pieces, and based on a mold wherein the pressing of the wet powder takes place in order to obtain a flat body that is subsequently subjected to drying and baking in order to obtain the final piece, wherein the tamper that carries out the pressing in the mold, has one or several punches or perforating elements comprised of respective hollow cylindrical bodies, partially embedded in said tamper and with a part emerging for its sticking in the wet powder during the pressing thereof.

4. Device for making perforations in ceramic pieces, according to claim 3, wherein the hollow perforating element or elements constitute vessels where the unpressed powder mass resulting from each perforation is contained.

5. Device for making perforations in ceramic pieces, according to claim 3, wherein the length of the part emerging from the perforating element or elements is the same or greater than the thickness of the flat body of pressed powder.

6. Device for making perforations in ceramic pieces, according to claim 4, wherein the length of the part emerging from the perforating element or elements is the same or greater than the thickness of the flat body of pressed powder.

7. Device for making perforations in ceramic pieces, according to claim 3, wherein the wet powder in the mold remains deposited on a special rubber sheet arranged on the base of said mold, whose sheet has, in the area opposite the perforating element or elements, a thickness that suffices to prevent said perforating element or elements from reaching the base of the mold at the end of the pressing.

8. Device for making perforations in ceramic pieces, according to claim 4, wherein the wet powder in the mold remains deposited on a special rubber sheet arranged on the base of said mold, whose sheet has, in the area opposite the perforating element or elements, a thickness that suffices to prevent said perforating element or elements from reaching the base of the mold at the end of the pressing.

9. Device for making perforations in ceramic pieces, according to claim 5, wherein the wet powder in the mold remains deposited on a special rubber sheet arranged on the base of said mold, whose sheet has, in the area opposite the perforating element or elements, a thickness that suffices to prevent said perforating element or elements from reaching the base of the mold at the end of the pressing.

10. Device for making perforations in ceramic pieces, according to claim 6, wherein the wet powder in the mold remains deposited on a special rubber sheet arranged on the base of said mold, whose sheet has, in the area opposite the perforating element or elements, a thickness that suffices to prevent said perforating element or elements from reaching the base of the mold at the end of the pressing.
